(19) United States
(12) Patent Application Publication
(10) Pub. No.: US 2024/0344303 A1
(43) Pub. Date: Oct. 17, 2024

(54) SYSTEM AND METHODS FOR HIGH-PERFORMANCE AMBIENT WATER HARVESTING

(71) Applicant: Purdue Research Foundation, West Lafayette, IN (US)

(72) Inventor: Tian Li, West Lafayette, IN (US)

(73) Assignee: Purdue Research Foundation, West Lafayette, IN (US)

(21) Appl. No.: 18/539,180

(22) Filed: Dec. 13, 2023

Related U.S. Application Data
(60) Provisional application No. 63/432,355, filed on Dec. 13, 2022.

(51) Int. Cl. E03B 3/28; B01D 53/28

(52) U.S. Cl. CPC E03B 3/28; B01D 53/28; B01D 2253/25

(57) ABSTRACT

An atmospheric water harvesting system may include a cellulose composite material. The composite material may include a cellulose scaffold comprising cellulose fiber bundles. Each of the bundles may include a plurality of fibers. Hygroscopic salt ions may be intercalated in the cellulose scaffold and bound to the cellulose fibers. Water may be extracted from the composite material.

### CROSS REFERENCE TO RELATED APPLICATIONS

This application claims the benefit of U.S. Provisional Application No. 63/432,355 filed Dec. 13, 2022 the entirety of which is hereby incorporated by reference.

### TECHNICAL FIELD

This disclosure relates to atmospheric water harvesting and, in particular, to composites for atmospheric water harvesting.

### BACKGROUND

About half of the world population, i.e. ˜ 4 billion people, undergo severe water scarcity at least seasonally, posing a systematic threat to humanity. Technologies, such as thermal desalination and solar steam generation, are being developed to mitigate the global freshwater crisis. However, these conventional approaches demand intense energy input and, most importantly, access to coastal water sources, such as precipitation, surface- or groundwater, limiting the applicability. In search of geographically independent water collection, atmospheric water harvesting (AWH) emerges as a promising candidate to extract water vapor with sanitary quality and potential scalability.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrate examples of an ambient water harvesting (AWH) system.

FIG. 2 illustrates an example of synthesis and morphology of an LiCl-cellulose composite.

FIG. 3A-G illustrates various views of a LiCl-cellulose composite scaffold.

FIG. 4A-D illustrates an example of an optical and thermal characterization of LiCl-cellulose composite.

FIG. 5A-F illustrates charts showing synergistic effects among radiative cooling, hygroscopic LiCl, and cellulose scaffold.

FIG. 6A-B illustrates charts showing a water uptake comparison with other sorption materials for AWH at the lower end and higher end of the RH spectrum.

FIG. 7A-C illustrates experimental results captured during various field tests.

### DETAILED DESCRIPTION

Atmospheric water vapor and droplets account for ˜10% of the global freshwater reservoir. Existing approaches to atmospheric water harvesting (AWH) can be categorized as either condensation-based or sorption-based devices. Condensation-based AWH systems rely on cooling or mechanical compressing to induce vapor-to-liquid phase transition. The major drawbacks of condensation include the requirement for high relative humidity (RH), e.g. fog harvesting, and/or sizeable energy input for cooling, which are not viable for arid and underdeveloped regions. In contrast to condensation, sorption-based AWH systems can work at a much wider RH range exploiting the hygroscopicity of adsorbents. Typical sorption materials include desiccator salts, metal-organic frameworks, and thermo-responsive gels. Strong water affinity contributes to water capture but hampers release. Yet to be resolved is the long-standing quest for simultaneous enhancement of water capture and release, two mutually exclusive processes. Sorption materials that are fully sustainable, cost-effective, and scalable are lacking. Previous endeavors have focused on individual mechanisms but have yet to fully exploit the potential of natural materials with hierarchical structures. Only limited success had been achieved on AWH devices with a wide working range and addressing the intrinsic conflict between water capture and release.

A technical advancement provided by the system and methods describe herein address the above-mentioned challenges by synergistically integrating multiple mechanisms, including thermosorption effect, radiative cooling, and multiscale cellulose water interaction, forming a highly integrated protocol that, to the best of our knowledge. We demonstrated the fundamental interplay of key components in a dual-mechanism AWH system by a LiCl-cellulose radiative cooling composite and documented its promising performance at both low and high RH. Moreover, we investigated the so-called temperature-swing strategy, i.e. triggering water capture and release by switching the system temperature to be hot and cold, respectively, to simultaneously achieve high water capture and release. Lab experiments, field tests, and theoretical modeling were conducted to elaborate how the microscopic LiCl-cellulose-water coupling and the environmental factors synergistically affected the macroscopic material performance. The multiscale theoretical model cross-validated the experimental water uptake with or without radiative cooling and predicted water uptake at a range beyond the experimental limits. An outdoor batch-mode AWH device demonstrated water capture (water uptake) as high as 6.75 L kg-1 day-1 (70% RH, 21.6° C.) and water production up to 5.97 L kg-1 day-1 under 0.9-1.1 sun. After eight continuous capture-release cycles, our AWH system produced 6.1 ml of water per day with a cost as low as 4.05 USD kg-1 (cellulose: 1.5 USD kg-1, salt: 10 USD kg-1 (27)). The efficient and high-performance AWH composite towards both ends of the RH spectrum is vital to both fundamental research and practical applications to account for the seasonal and climate variation of the RH, especially in arid areas (such as the Death Valley), that vary between 5% and 95% RH most years.

System and methods are provided for achieving water harvesting in a wide ambient condition. The system ad methods described herein synergistically combine radiative cooling and hygroscopic sorption scaffold. A multiscale scaffold biopolymer (plurality of cellulose fibers, chitin and hydrogel) with hygroscopic salt (LiCl, CaCl₂) and MgCl₂) may be utilized for a sorption material in an ambient water harvesting system.

The proposed system synergistically integrates passive cooling and sorption effects into a positive feedback loop: Cooling enhances moisture harvesting; while sorption promotes infrared-range emission power which leads to a stronger radiative cooling effect. 1) multiscale cellulose fiber-photon interaction induces radiative cooling, for example, the fiber size of cellulose (nm) is comparable to the wavelength in the visible and ultraviolet range, the incident visible light can be largely backscattered and thus attribute to the cellulose white appearance. Meanwhile, the microscale fibers and fiber bundles (μm) act as the optical scattering centers making the cellulose samples opaque in the mid-infrared (MIR) regime. The multimode molecular vibrations (O—H stretching vibration and C—O—H bending) provide the cellulose with a strong optical emission. This passively cooled fiber network lowers the water activity under a given ambient condition, shifts up sorption isotherm, and even reduces the fiber temperature below the dew point towards local condensation, and further enhances the hydration reaction rate of the coated hygroscopic salt of reaching the equilibrium state. 2) The fiber-water interaction and the water adsorbed on the fibers will increase the overall infrared emissivity of the sample, leading to a higher cooling power. This yields an exceedingly high equilibrium harvesting capacity, which has been a major bottleneck of conventional ambient water harvesting devices. 3) In addition, the inherent optical and thermal property of the proposed material allows an easy self-adaptive switch between water capture by radiative cooling and water release by solar thermal heating for multicyclic operations.

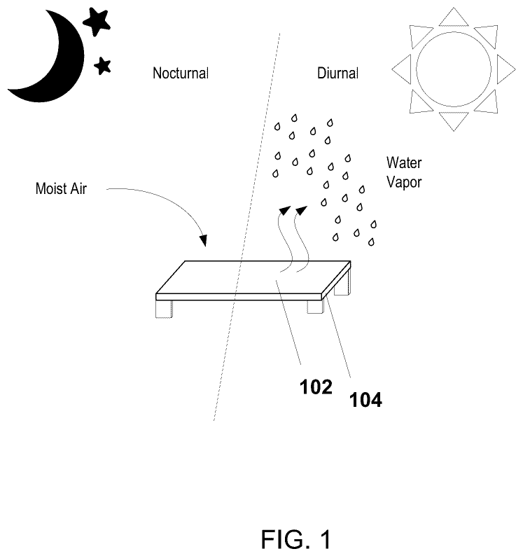

FIG. 1 illustrate examples of an ambient water harvesting (AWH) system. The system may be located in other areas which have exposure to the atmosphere. For example, the AWH may be situated on a roof top. The system may include a cellulose composite fabric 102. The cellulose composite material 102 may include a cellulose scaffold having cellulose fibers and hygroscopic salt ions intercalated in the cellulose scaffold and bound to the cellulose fibers. In some examples, the cellulose composite fabric may placed or stretched across a substrate 104.

Cellulose, one of the most abundant biopolymers on earth, has many unique functional properties including robust mechanics, strong hydrophilicity, carbon-neutrality, etc. . . . Moreover, recent studies observed the radiative cooling effect of cellulose, a mechanism which gave rise to several new applications. Cellulose materials emit thermal radiation when facing the sky. The emitted radiation escapes the earth through the atmospheric transparent window (8-13 μm) and ends up in the ultracold universe. The emitted heat exceeds the adsorbed solar heat resulting in a net cooling effect at zero energy cost. Cooling is highly beneficial for AWH because it not only facilitates the exothermic sorption process, but also lowers the saturation vapor pressure which consequently promotes condensation. Radiative cooling and sorption form a positive feedback loop. Cooling promotes sorption while the adsorbed water molecules contribute to an even higher cooling power due to their high mid infrared (MIR) emissivity. Though cellulose is hygroscopic and can adsorb up to ˜40% water, it is not an ideal AWH material alone.

Cellulose-based fabrics feature a hierarchical structure. The well-dispersed ions recrystallize and bind tightly to the cellulose surfaces. The aspect ratio of fibers is greater than 100 and the length is greater than 1.5 mm. The long fibers and partially densified fiber network provide strong physical entanglement, leading to desirable flexibility and high mechanical strength. The microscale cellulose fibers are further composed of aligned cellulose nanofibers. The overall porosity is >90%. The fiber bundle is composed of multiscale features including microscale fiber bundles ˜20 μm in diameter to nanofibers ˜20 nm in diameter. The hydrophilic surface as well as the numerous channels between fibers and fiber bundles facilitate the salt solution infiltration process. The intrinsically hydrophilic and highly porous fiber network efficiently captures and stores water.

The cellulose scaffold can be impregnated with LiCl, one of the most hygroscopic salts at a low RH, to boost its water harvesting ability. LiCl salt adsorbs limited amounts of water at low RH conditions (<5% RH), but when the RH is raised above 11%, the deliquescence point (RHₒ) of LiCl, the salt will deliquesce, forming a saturated solution that can ultimately take up more than 1000% water content as the RH is elevated further. LiCl desiccant is also advantageous in terms of water release, as LiCl regenerates at 40° C., a temperature readily obtainable via solar heating. Impregnation of LiCl in the cellulose multiscale hierarchical pore network extends the working RH range and boosts the water harvesting capacity and kinetics. The cellulose scaffold, in return, structurally supports LiCl and retains the water and LiCl solution. The aggregation, agglomeration, and deliquescence commonly observed in LiCl powder are alleviated in the cellulose scaffold for a non-degraded sorption capability. The hydrated LiCl-cellulose composite increases optical transparency across the solar spectrum and allows rapid water evaporation by solar heating with a dark substrate underneath. Cycles of radiative cooling and solar heating shift the system temperature between low and high favoring water capture and release respectively, i.e. the so-called temperature-swing strategy. This yields an exceedingly high harvesting capacity which has been one of the major bottlenecks in conventional ambient water harvesting systems.

Other types of hydroscopic salt ions may be used in addition to, or alternatively to LiCl. For example, CaCl₂ and MgCl₂ are other types of hydroscopic salt ions which may be used.

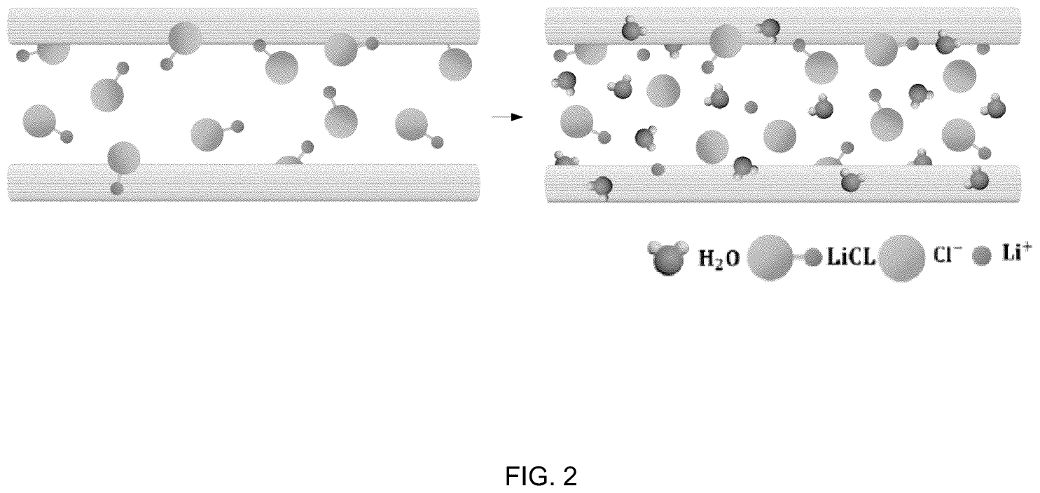

FIG. 2 illustrates an example of synthesis and morphology of an LiCl-cellulose composite. To fabricate the LiCl-cellulose composite, the cellulose scaffold may be immersed into LiCl solution and then oven dried. The LiCl ions gradually intercalate into the cellulose fiber matrix during the thrice dipping-drying steps. Following the oven drying process, the well-dispersed ions recrystallize and bind tightly to the cellulose surfaces. The cellulose scaffold can hold up to 50 wt % of the LiCl salt without noticeable leakage.

The composite material can also be fabricated with alternative methods as follows. For example, in another example, the composite material may be formed by dissolving cellulose nanofibers and salt powder in organic solvent to form a clear solution. Using a syringe equipped with a needle to inject the as-prepared solution with a certain flow rate. Carrying out the electrospinning at room temperature and relative humidity. Settling the voltage difference and tip-to-collector distance. Using a drum wrapped with a layer of Al film to collect the cellulose nanofibers embedded with salt.

Increasing the salt concentration in cellulose fabric by vacuum infiltration. Immersing a cellulose scaffold in high concentration LiCl solution and then putting into high vacuum chamber. After certain time, releasing the vacuum to end vacuum infiltration. The LiCl will intercalate amongst the cellulose structure. Repeating the process for 10 times to reach the enough high concentration. Drying the previously immersed cellulose fiber to cause the LiCl ions to bind to cellulose fibers and form an LiCl-cellulose composite.

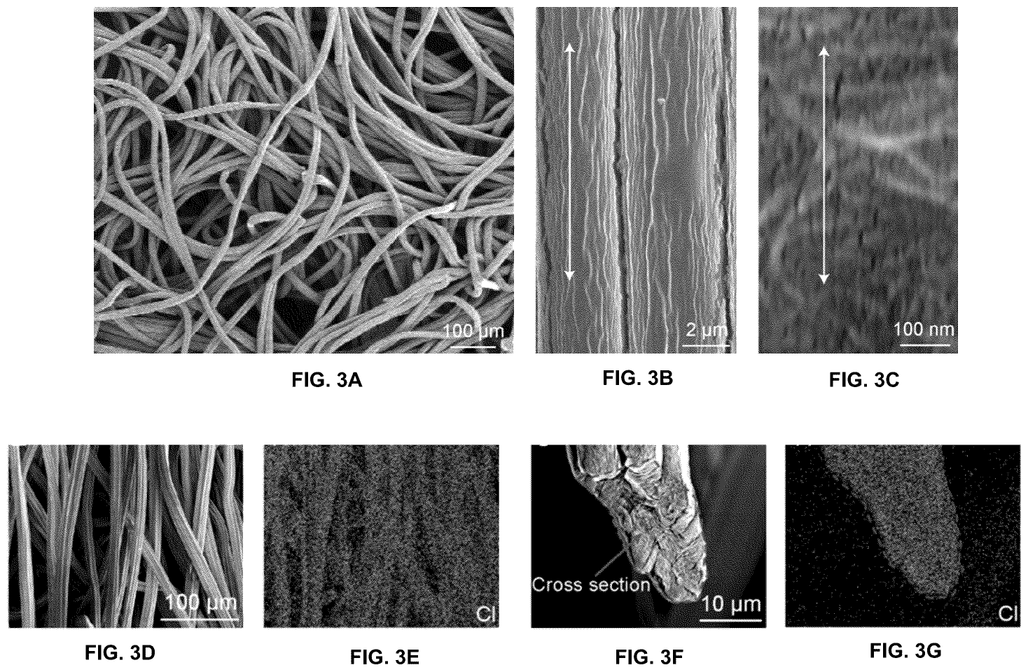

FIGS. 3A-G illustrates various views of a LiCl-cellulose composite scaffold. FIG. 3A illustrates SEMs of LiCl-cellulose composite composed of entangled cellulose fiber bundles. FIG. 3B illustrates a magnified view of the fiber surface. FIG. 3C illustrates a partially aligned cellulose nanofibers. FIG. 3D illustrates a cellulose fiber network. FIG. 3E illustrates a corresponding EDX mapping of CI shows the coating uniformity. FIG. 3F illustrates a cross-section view of the cellulose fiber bundle. FIG. 3G illustrates a corresponding CI mapping demonstrates that LiCl is impregnated into the fibers by intercalation.

The high aspect ratio of the fiber bundle is composed of multiscale features including microscale fiber bundles ˜20 μm in diameter to nanofibers ˜20 nm in diameter (FIG. 3A-C). The LiCl brine solution quickly infiltrates the cellulose scaffold and the salt ions achieve nanoscale dispersion, as indicated by the energy-dispersive X-ray spectroscopy (EDX) mappings of fiber networks and cross-sections (FIG. 3D-G). The hydrophilic surface as well as the numerous multiscale channels, revealed in the scanning electron microscope (SEM) images (FIG. 3A-G), facilitate the salt solution infiltration process. The intrinsically hydrophilic and highly porous fiber network efficiently captures and stores water. Our solution-based salt impregnation process can be easily incorporated into the well-established cellulose-based paper, textile, and membrane manufacturing process. All these enable the fast deployment of the proposed device, opening industrialization opportunities.

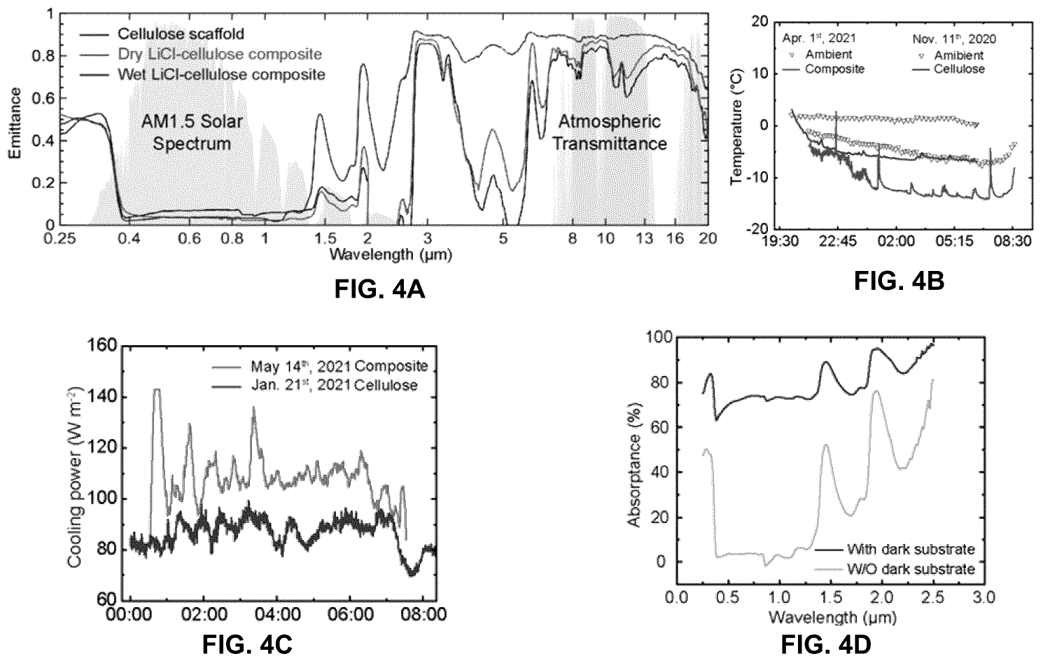

FIG. 4A-D illustrates an example of an optical and thermal characterization of LiCl-cellulose composite. FIG. 4A illustrates emissivity in the ultraviolet, visible, and infrared range of the cellulose and LiCl-cellulose composite in dry and wet conditions. FIG. 4C Profiles of the sample surface temperatures and ambient temperature of cellulose scaffold and LiCl-cellulose composite. FIG. 4C illustrates profiles of the cooling power measured for the cellulose scaffold and LiCl-cellulose composite. FIG. 4D illustrates an absorptance spectra of LiCl-cellulose composite with and without dark substrate.

As shown in FIG. 4A shows the emittance over the wavelength range 250 nm-20 μm, i.e. solar spectrum and sky transmittance spectrum, of the cellulose scaffold and LiCl-cellulose composite in dry and wet states. More than 95% of solar irradiation is intensely backscattered by the nanofibers and microfibers at the corresponding length scale (400-1500 nm) redound to a low solar absorption. The microfibers and larger fiber bundles (2-20 μm) contribute to amplifying and broadening the emittance peaks to increase the radiative energy leaving the composite. The particularly strong MIR radiation of cellulose stems from the multimode vibrations of molecular chains, including C—O stretching, C═C bending, and O—H stretching, where the emission wavelengths align with the atmospheric sky window (8-13 μm), permitting energy dissipation to deep space. The aforementioned light-matter interactions provide the LiCl-cellulose composite a selective emittance spectrum that allows a spontaneous and rapid cooling to sub-ambient surface temperature. Wet samples emit stronger than dry ones because the additional hydrogen bonding between the OH¬-branches and H2O molecules complements the missing molecular vibration modes. Also, bulk water itself is a good IR emitter with near-unity emissivity. These clearly suggest that sorption and radiative cooling mutually enhance each other, forming a positive feedback loop, a merit of system design. The effective emissivity over the atmospheric window is 0.75 for the cellulose scaffold in the dry condition and is enhanced to 0.80 when coated with LiCl.

Field tests were conducted to demonstrate the functionality of the AWH composite in real environments. Water harvesting tests were carried out during nights from November 2020 to May 2021 in West Lafayette, IN (40.4237° N, 86.9212° W). Radiative cooling effectively reduces sample to 6.0-8.7° C. below ambient temperature, as shown by the representative data of Apr. 1, 2021 and Nov. 11, 2020 at an RH range of 48%-82% (FIG. 4B). The sporadic temperature surge in FIG. 4B is caused by manual measurement of sample weight. The radiative cooling power measured by a feedback heater (FIG. 4C) exhibits an average cooling power of 110 W m-2 for LiCl-cellulose composite during the night of May 14, 2021 and 82.3 W m-2 for the cellulose scaffold during the night of Jan. 21, 2021. The cooling power difference was a consequence of different climate conditions. The LiCl-cellulose composite had a higher cooling power when the test was conducted under a higher ambient temperature and low absolute humidity during the summer. We present a theoretical model to estimate the cooling power at different ambient temperatures based on the measured optical emittance of the three samples, wherein the wet composite had highest cooling power while dry cellulose scaffold had the lowest. Rapid water release is achieved by placing a dark substrate underneath the LiCl-cellulose composite during the daytime. The LiCl-cellulose composite transmits more sunlight when it is wet because of the better match of the refractive indices of cellulose and the surrounding medium. The wet composite on a dark substrate has a solar absorption of 67.7% to facilitate water release (FIG. 4D). The numerous channels and fiber surfaces serve as transport paths contributing to the release of tightly stored water. The outdoor cellulose scaffold demonstrates a passively cooled composite under direct solar irradiation.

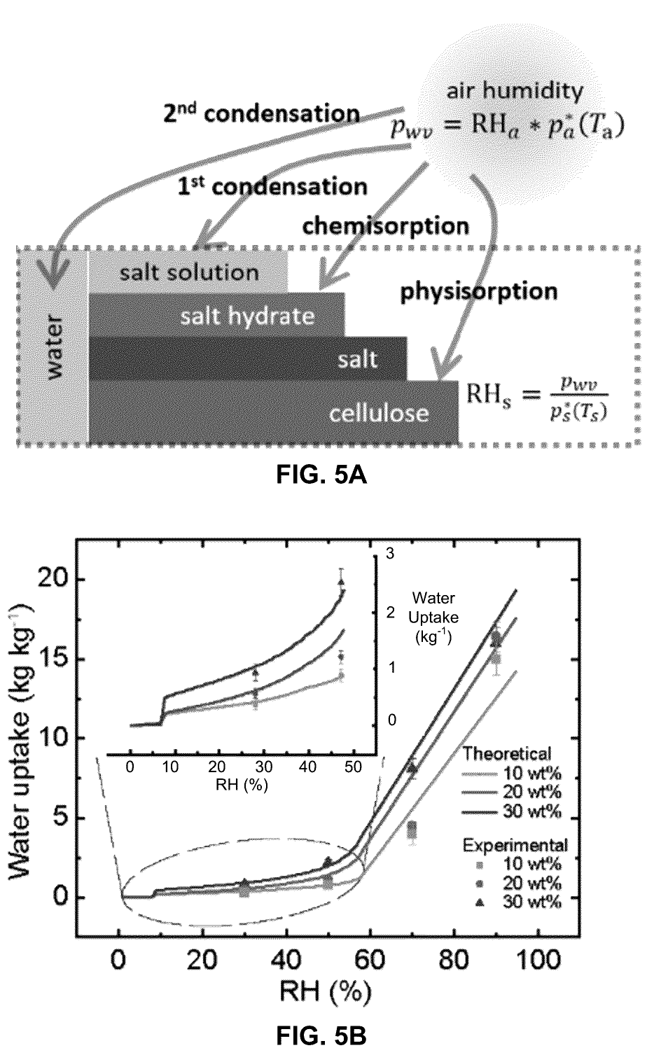

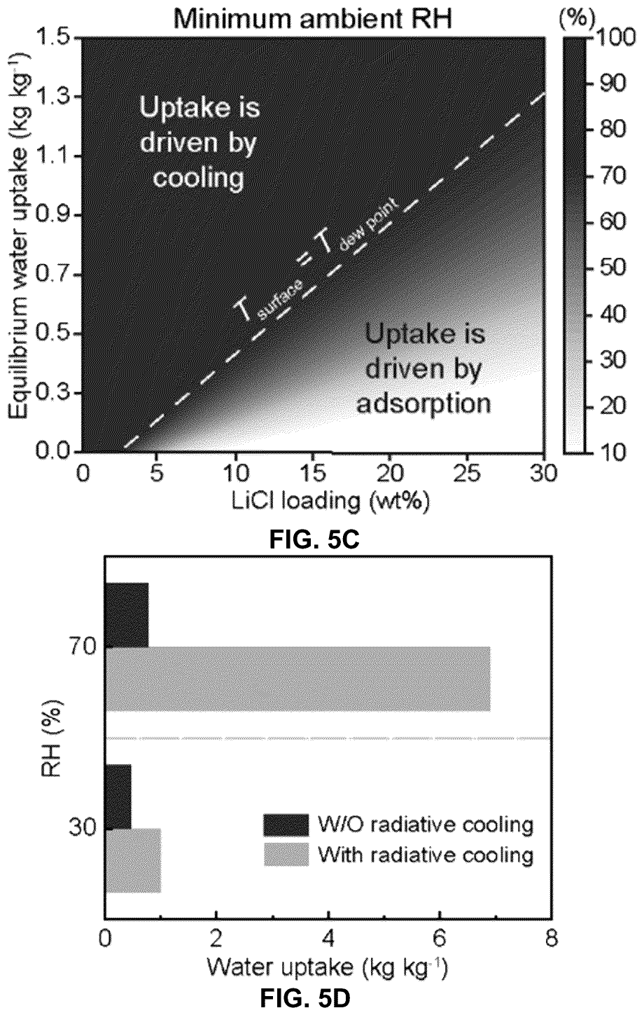

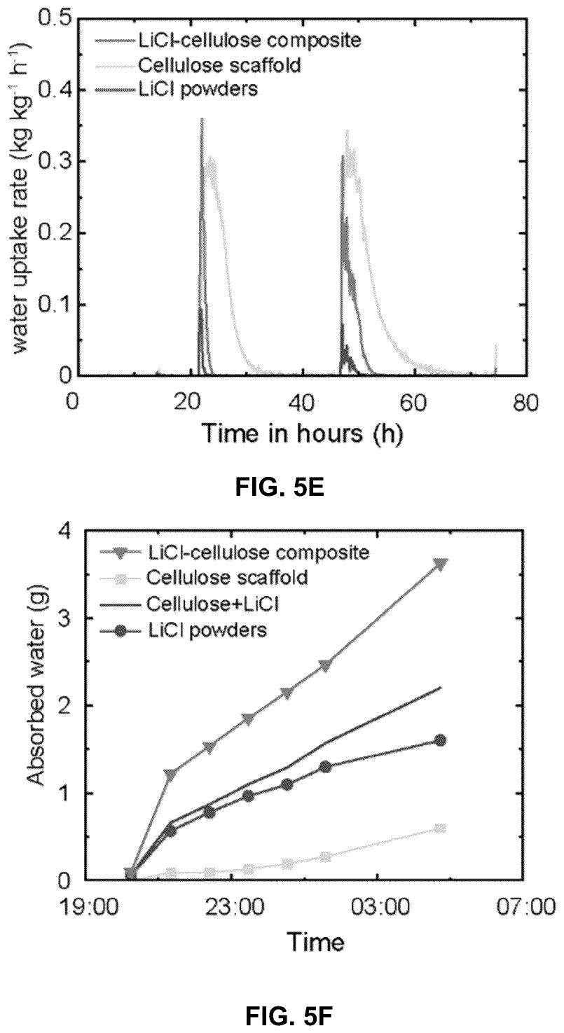

FIG. 5A-F illustrates charts showing synergistic effects among radiative cooling, hygroscopic LiCl, and cellulose scaffold. FIG. 5A illustrates experimental and theoretical water uptake of LiCl-cellulose composite samples (10-30 wt %) with radiative cooling. FIG. 5B illustrates experimental and theoretical water uptake of LiCl-cellulose composite samples with 10-30 wt % at 0-100% RH. Inset is an enlargement of the experimental and theoretical water uptake from 0-50% RH. FIG. 5C illustrates maximum water uptake as function of RH for 6° C. below the 25° C. ambient temperature. FIG. 5D illustrates a comparison of water uptake of LiCl-cellulose composite with and without radiative cooling effect at 30% and 70% RH. The LiCl-cellulose composite has a 30 wt % loading. FIG. 5E illustrates the rate of change of water uptake of cellulose, LiCl, and LiCl-cellulose composite samples based on sorption isotherm characterization. FIG. 5F illustrates collected water mass as a function of time during the field test of cellulose scaffold, LiCl powder, and LiCl-cellulose composite.

To further elucidate the working mechanism of the LiCl-cellulose composite, we individually analyzed and decoupled the synergistic effect of the radiative cooling, hygroscopic LiCl, and cellulose fibril structure. At the atomistic scale, the water dipole attracts the counter-ions and breaks the ionic bonds of LiCl leading to its dissolution. Meanwhile, the polar hydroxyl groups on cellulose chains hydrogen bond strongly with polar water molecules. The multiscale pore structure of the cellulose scaffold facilitates water harvesting with micropore filling, capillary condensation, and mono/multilayer adsorption mechanisms. On the nanoscale, the sorption potential of the surfaces overlaps thus creating strong attraction promoting nucleation. The adsorption can occur even at low RH. The smaller the pore size, the higher the moisture sorption potential. The fibers at this scale are cellulose aggregates. On the micrometer scale, a large volume of water is retained via capillary forces. Condensation happens at sub-saturation vapor pressure, as described by the Kelvin equation. The porous structure at this scale denotes larger scale fiber assemblies. Larger scale structures, such as the fiber network, transport water mimicking desert plants. Single fibers include a bundle of cells. The enhanced water capturing performance stems from four mechanisms FIG. 5A: 1. Physisorption of cellulose; 2. Chemisorption of LiCl, i.e. forming LiCl hydrates; 3. Sorption of water vapor into LiCl solution (here called 1 st condensation), occurs when RH is higher than the RHₒ; 4. Condensation of water vapor due to vapor saturation (here called 2^{nd} condensation). Each of these mechanisms can be described by the corresponding physical models. The physisorption is frequently represented by the Guggenheim-Anderson-de Boer (GAB) sorption model. The LiCl-water interaction can be described by the phase diagram. Isolated water condensation (2^{nd} condensation) is a (quasi) linear function of time assuming heat and mass transfer reaches equilibrium. With these considerations, the theoretical model of the composite is taken as the weighted summation of the four mechanisms.

Controlled experiments are conducted in an environmental chamber. The working mechanisms are identical to the field test but with precise control of the cooling power, ambient temperature, and RH for a systematic performance evaluation (Note S8). FIG. 5B displays the water uptake curves of 6° C. temperature drop from 25° C. ambient temperature, 10-30 wt % LiCl content. Sorption dominates the water uptake until RH >60% where condensation commences and dominates. At ˜8% RH, sorption surges due to the onset of salt deliquescence. The theoretical model quantitatively agrees with the experiments, which demonstrate that radiative cooling substantially improved the water capture. The required RH for water uptake is shown in FIG. 5C. Modeling results break down the regimes where the two mechanisms dominate performance. In sub-dew point temperature conditions, the uptake is driven by a balance between the cooling power and condensation heat transfer. Whereas above the dew point, the water uptake is adsorption driven. The lab tests reveal a 2-fold and 9-fold increase of water uptake solely due to the 6° C. cooling of the composite at 30% and 70% RH respectively (FIG. 5D). The effect of radiative cooling on the water uptake is more pronounced at higher RH since the physical water vapor condensation starts to dominate the water capturing. A comparative field test conducted using two pieces of 30 wt % LiCl-cellulose composite, with one exposed to the sky and the other shielded by non-transmissive cardboard, also shows the radiative cooling effect on the enhancement of water uptake.

In addition to the synergistic thermosorption effect that enhances water capture capacity, water capture kinetics is greatly expedited by dispersion, as indicated by the results of dynamic vapor sorption experiments (FIG. 5E) and field tests that recorded water uptake vs. time curve (FIG. 5F). More specifically, in terms of the rate of water uptake, LiCl-cellulose composite has a synergistic higher rate of water uptake and outperforms the summation of LiCl powder and cellulose scaffold. We employed nitrogen sorption isotherm measurement to characterize the surface area of LiCl, cellulose scaffold, and LiCl-cellulose composite. The LiCl-cellulose composite has a Brunauer-Emmett-Teller (BET) equivalent surface area of 0.331-0.366 m² g⁻¹, while the values of cellulose scaffold and LiCl powders are 0.177 and 0.047 m² g⁻¹ respectively. The impregnated LiCl is dispersed and attached to the large surface area of the cellulose scaffold, resulting in a much greater surface area for the composite which expedites sorption kinetics. The derivative of the water uptake vs. time curve is computed to compare the rate of absorption of the three samples and supports this hypothesis (FIG. 5E). The LiCl-cellulose composite absorbed more water compared to the sum of the cellulose scaffold and the LiCl powder in the field test, which reinforces the initial hypothesis (FIG. 5F).

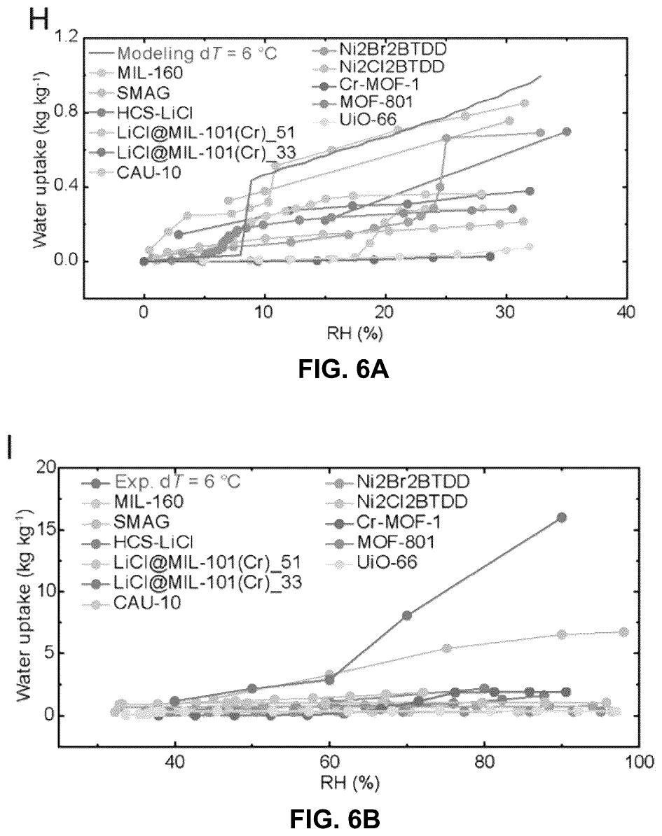

FIG. 6A-B illustrates charts showing a water uptake comparison with other sorption materials for AWH at the lower end and higher end of the RH spectrum. The developed LiCl-cellulose composite shows higher water uptake capacity than most of the recently reported AWH sorbent materials under all weather conditions (8%-90% RH) (comparisons of which are shown in FIG. 6A-B).

### Field Experimentation

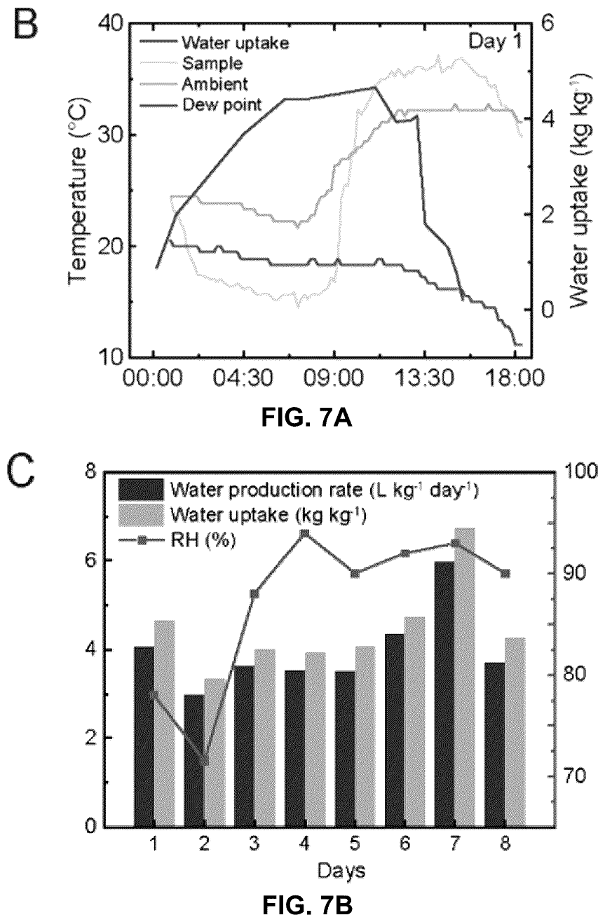

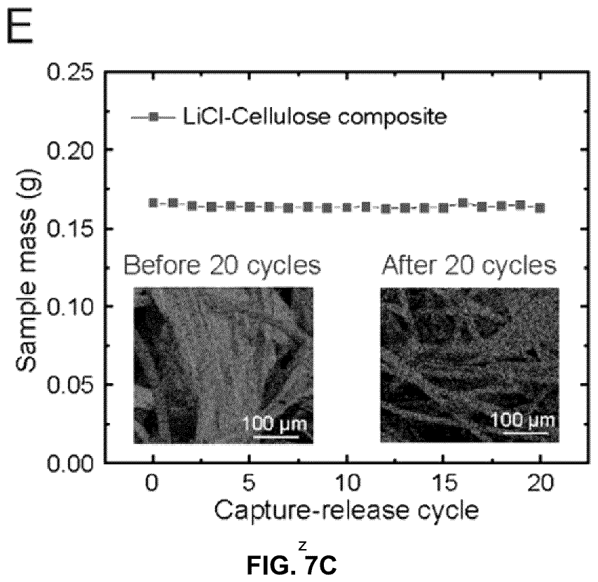

FIG. 7A-C illustrates experimental results captured during various field tests. FIG. 7A illustrate temperature and water uptake of a 30 wt % LiCl-cellulose composite during a field test. FIG. 7B illustrate Field test results of 8 days including water collection in grams and water uptake in kg kg-1. FIG. 7C illustrate dry mass of 30 wt % LiCl-cellulose composite during 20 capturing-releasing cycles, which exhibit the LiCl is stable and will not leak from the composite for a durable application.

Outdoor field tests were conducted under natural sunlight to characterize system performance in real-life scenarios. A batch-mode AWH device including a thin-wall and clear acrylic container and a LiCl-cellulose composite with a dark substrate is prototyped. During the nighttime, the lid of the acrylic container is opened, exposing the LiCl-cellulose composite (approximate dimension 10×15×0.1 cm³) to the sky and the composite captures water from the ambient air. During the daytime, the container is sealed. Driven by the solar heating, the water captured during the night evaporates and continuously condenses on the inner wall of the acrylic as the composite temperature increases. Then the liquid water flows down along the slope of the top container and accumulates in the corner.

An eight-day AWH was demonstrated on Jun. 13-14 and Jul. 2-Jul. 7, 2021, where the discontinuation is due to weather disruption. FIG. 7A exemplifies one day of water harvesting (June 13^{th}) where the ambient temperature, sample surface temperature, and dew point are monitored. The water uptake of LiCl-cellulose composite consistently increases during the entire capturing process. The final water uptake on the first day reaches 4.66 kg kg⁻¹. Sunrise begins at 6:16 AM, the outdoor temperature quickly increased from 22° C. to 28° C. and the RH decreased from 78% to 59%. At 11:03 AM, the acrylic container is sealed and the water releasing process starts. Within 1 min, the inner wall of the device starts to mist, and the transparent container becomes translucent after 5 minutes. The evaporated water gradually condensed on the inner wall of the device. Between 11:03 AM and 3:24 PM, the device harvests 6.93 g of liquid water, which is 90% of the captured water in the LiCl-cellulose composite. FIG. 7B demonstrated the repeatability of the liquid water collection in the field test on the next seven consecutive days, where the highest water uptake is 6.75 kg kg⁻¹ on July 6^{th}.

The ionic conductivity test shows that the quality of the collected water is better than tap water. Capture-release cycles are repeated 20 times in lab tests. The water release is initiated by a solar simulator. The composite is shown to be durable without notable degradation as revealed by the stable weight and the EDX mappings of chlorine in the LiCl-cellulose composite (FIG. 7C). All of the material characterizations and performance demonstrations confirm that the LiCl-cellulose composite is a potential candidate for achieving highly efficient AWH due to its distinct advantages of extremely high water sorption capacity at low humidity, relatively low desorption energy, fast water sorption-desorption kinetics, continuous sub-ambient cooling, and good cyclic stability. With a comprehensive understanding of the mechanisms and performance of LiCl-cellulose composite, especially its noticeable portability, scalability, and high water uptake, we then model and predict the potential daily water production on a global scale using the performance characterized in the lab test. The modeling takes the global climate data from national centers for environmental prediction (NCEP) of the year 2020 and interpolated the amount of daily water production solely based on the local relative humidity. Assuming a scaling factor of ⅓ to exclude days of low daily clearness index and limited radiative cooling effect, there is still a non-zero annual production of clean water even in the most draught region. The maximum cumulative water production can reach 1200 L m⁻¹ in some insular and peninsular areas where the humidity level is high, but the freshwater resource is scarce. As climate conditions differ city by city, the LiCl-cellulose composite can harvest four times more water from the atmosphere in Bamako than in Lanzhou, for example, during the humid summers. In other example, the average daily water production is 10.6 L kg⁻¹ day⁻¹ in Phoenix, AZ, USA; therefore, a 3 m² of the LiCl-cellulose composite may, for example, be needed to meet the daily water usage need including cooking, drinking, and hygiene. The high performance LiCl-cellulose composite has the potential to mitigate the water shortage and the associated global challenges.

The system and methods described herein provide a full functionality and high-efficiency AWH by the passive radiative cooling LiCl-cellulose composite working across a wide range of RH (>8% RH, 25° C.) and provide synergistically integrated: 1) dispersed hygroscopic LiCl for moisture sorption and liquefaction, 2) multiscale cellulose structure for water storage and transport, 3) passive radiative cooling enhancing sorption and condensation with zero energy consumption, and 4) photothermal conversion by a dark substrate for rapid water release, i.e. temperature-swing strategy. The established multiscale understanding involving multiscale pores, sorption mechanisms, and radiative cooling effect well validates and predicts the experimental water uptake and explains the synergy among the composite-water-energy interaction. Field tests demonstrate a water production rate of >5.97 L kg⁻¹ day¹ under 0.9-1.1 sun. These synergistic functions render an extraordinarily promising and scalable approach for an atmospheric water harvesting system with high production rate, cost-effectiveness, environmental friendliness, high stability, and completely safe water collection. The rational system design utilizing the multiscale structure of cellulose, multi-mechanism synergistic effect, and temperature-swing strategy paves the way for futuristic advanced AWH systems.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A composite material for atmospheric water harvesting, the composite material comprising:
A cellulose scaffold comprising a plurality of cellulose fiber bundles, each of the bundles comprising a plurality of fibers; and
hygroscopic salt ions intercalated in the cellulose scaffold and bound to the cellulose fibers.

2. The composite material of claim 1, wherein the hydroscopic salt ions are LiCl, CaCl2, MgCl2, or a combination thereof.

3. The composite material of claim 1, wherein the aspect ratio of fiber bundles is greater than 100 and the length is greater than 1.5 mm.

4. The composite material of claim 1, wherein the fibers of the cellulose fiber bundles are aligned.

5. The composite material of claim 1, wherein the cellulose fibers bundles are between ˜20 μm in diameter to ˜20 nm in diameter.

6. A atmospheric water harvesting system comprising:
a cellulose composite material, the composite material comprising a cellulose scaffold comprising a plurality of cellulose fiber bundles, each of the bundles comprising a plurality of fibers; and
hygroscopic salt ions intercalated in the cellulose scaffold and bound to the cellulose fibers,
wherein water is extracted from the composite material.

7. The atmospheric water harvesting system of claim 6, wherein the hydroscopic salt ions are LiCl, CaCl2, MgCl2, or a combination thereof.

8. The atmospheric water harvesting system of claim 6, wherein the aspect ratio of fiber bundles is greater than 100 and the length is greater than 1.5 mm.

9. The atmospheric water harvesting system of claim 6, wherein the fibers of the cellulose fiber bundles are aligned.

10. The atmospheric water harvesting system of claim 6, wherein the cellulose fibers bundles are between ˜20 μm in diameter to ˜20 nm in diameter.
